(19) United States
(12) Patent Application Publication
(10) Pub. No.: US 2005/0232237 A1
(43) Pub. Date: Oct. 20, 2005

(54) Method for listenting to on-line radio station through webphone

(75) Inventors: Chia-Ming Hsu, Taipei (TW); An-Teng Chang, Taipei (TW)

Correspondence Address: BRUCE H. TROXELL, SUITE 1404, 5205 LEESBURG PIKE, FALLS CHURCH, VA, 22041, US

(73) Assignee: Kinpo Electronics, Inc.

(21) Appl. No.: 10/825,107

(22) Filed: Apr. 16, 2004

(51) Int. Cl. H04L 12/66

(52) U.S. Cl. 370/352; 370/310

(57) ABSTRACT

A method for listening to an on-line radio station through a webphone comprises the following steps: a CPU continues detecting a webphone system whether there is an incoming phone call or a dialing-out phone call; if yes, allows the system to close a broadcasting mode of an on-line radio station and to activate general dialing/receiving mode of a webphone; if no, allows the system to activate the broadcasting mode of the on-line radio station; the CPU allows the system to execute the broadcasting mode. The present invention provides a webphone having a broadcasting function of an on-line radio station while standing by. Therefore, a webphone can have more functions and use values.

### BACKGROUND OF THE INVENTION

1. Field of the Invention

The present invention relates to a webphone, and more particularly to a method for allowing a webphone to have an on-line radio station listening function.

2. Description of Related Art

It is very convenient to transmit and collect information by using Internet. Connecting a personal computer to Internet and using such as Window Media Player can allow various kinds of video and audio information to be broadcasted by choosing a connection with every kind of website providing video and audio programs. There are many websites with a plurality of on-line radio stations broadcasting music programs anytime. A person can connect a personal computer to a website with on-line radio stations through Internet to listen to a speech sounds program broadcasted from an on-line radio station.

Internet is used for a webphone to process a real time video and audio signals transmission. Until now, a plurality of patents about the technologies of webphones are disclose, such as Taiwan patent publication No. 564,662 that discloses a webphone device and a method for dialing a webphone and publication No. 416,202 discloses a webphone communication system.

Please refer to FIG. 1. A general webphone comprises a CPU 10 that is respectively connected to a keyboard 11, signal transformer 12, flash memory 13, liquid crystal display 14 and sound effects processor 15. The signal transformer 12 is further connected to an Internet connection interface 16 in order to have a connection with Internet. The sound effects processor 15 is further connected to an amplifier 17 and microphone 18. The amplifier 17 is further connected to speakers 19. The microphone 18 and the speakers 19 can be the ones on a telephone transmitter. A power supply module 20 provides necessary electricity for each element. Various kinds of buttons on the keyboard 11 have used for an operator to control the CPU 10 to process a dialing and every kind of function setting. The signal transformer 12 is used to allow signals in a webphone system to transform to Internet transmission signals or vice versa. For example, audio signals received by the microphone 18 is processed by the sound effects processor 15, and then the CPU 10 can control the signal transformer 12 to transform the audio signals to signals conforming to Internet transmission to be sent to Internet through the Internet connection interface 16. And, the CPU 10 can control the signal transformer 12 to transform video and audio signals inputted through the Internet connection interface 16 to video and audio signals that can be broadcast by the liquid crystal display 14 and speech sounds signals that can be processed by the sound effects processor 15. Images are broadcasted through the liquid crystal player 14. The speech sounds signals processed by the sound effects processor 15 is transmitted to the speaker 19 and broadcasted by the speaker 19 after it is amplified by the amplifier 17.

The difference between a webphone and traditional telephone is that the webphone is stayed at the state of connection with Internet any time, i.e. the webphone is in a standby state waiting for an incoming phone call and waiting for being used. And, there are no other useful applications at the interval that the webphone is not used. To the tendency that every kind of information product is developed toward multi-functions and multi-applications at the present time, there is a space for a current webphone to be further reinforced on application and usage.

### SUMMARY OF THE INVENTION

The main object of the present invention is to provide a method for listening to an on-line radio station through a webphone, enabling a webphone to have a broadcasting function of an on-line radio station while standing by. Therefore, a webphone can have more functions and use values.

Other objects and features of the present invention will be apparent by way of following description of embodiments with accompanying drawings.

### BRIEF DESCRIPTION OF THE DRAWINGS

The present invention can be more fully understood by reference to the following description and accompanying drawings, in which:

FIG. 1 is a schematic block diagram, showing a structure of a conventional webphone;

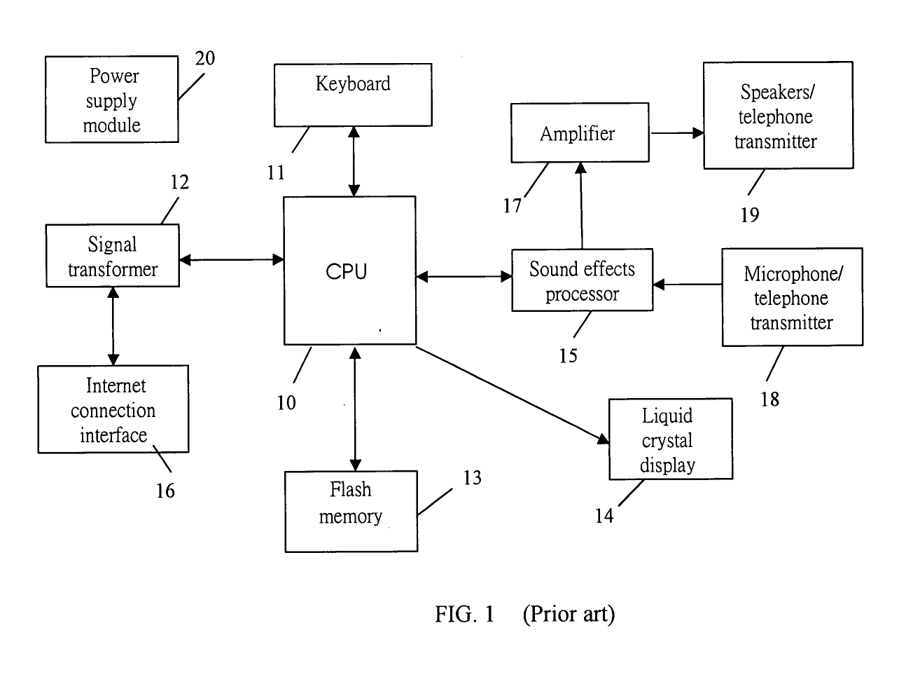

FIG. 2 is a flow chart, illustrating steps for listening to an on-line radiation station through a webphone system according to the present invention; and

FIG. 3 is a flow chart, illustrating steps for executing broadcasting mode of an on-line radiation through a webphone system according to the present invention.

### DETAILED DESCRIPTION OF THE PREFERRED EMBODIMENTS

The present invention mainly not only allows a webphone system to be able to execute a general webphone dialing/receiving mode, but also comprises an on-line radio station broadcasting mode to allow a webphone to be able to execute the on-line radio station broadcasting mode so as to broadcast a speech sounds program from the on-line radio station while it is at a standby state.

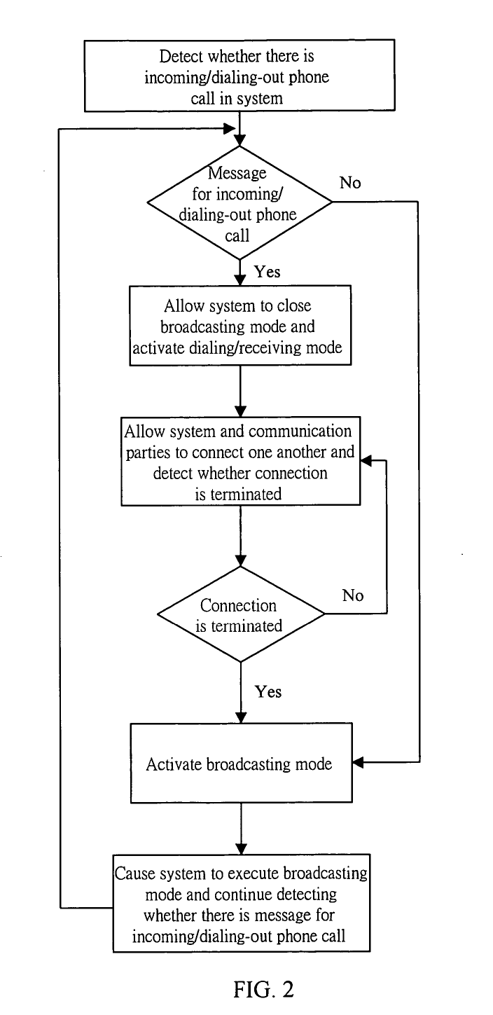

Please refer to FIG. 2. A method for listening to an on-line radio station through a webphone comprises the following steps:
(a) a CPU continues detecting a webphone system whether there is an incoming phone call or a dialing-out phone call; if yes, allow the system to close a broadcasting mode of an on-line radio station and to activate general dialing/receiving mode of a webphone, and enter next step; if no, enter Step (c);
(b) the CPU allows a line connection to be established among the system and two telephone communication parties; and, detects whether the line connection between the two parties is terminated; if no, continues detecting; if yes, enter next step;
(c) allows the system to activate the broadcasting mode of the on-line radio station;
(d) The CPU allows the system to execute the broadcasting mode;
(e) the CPU continues detecting the webphone system whether there is a message for an incoming phone call of a dialing-out telephone; if yes, causes the system to close the on-line radio station broadcasting mode and to activates the general webphone dialing/receiving mode, and then return back to Step (b); if no , return back to Step (d).

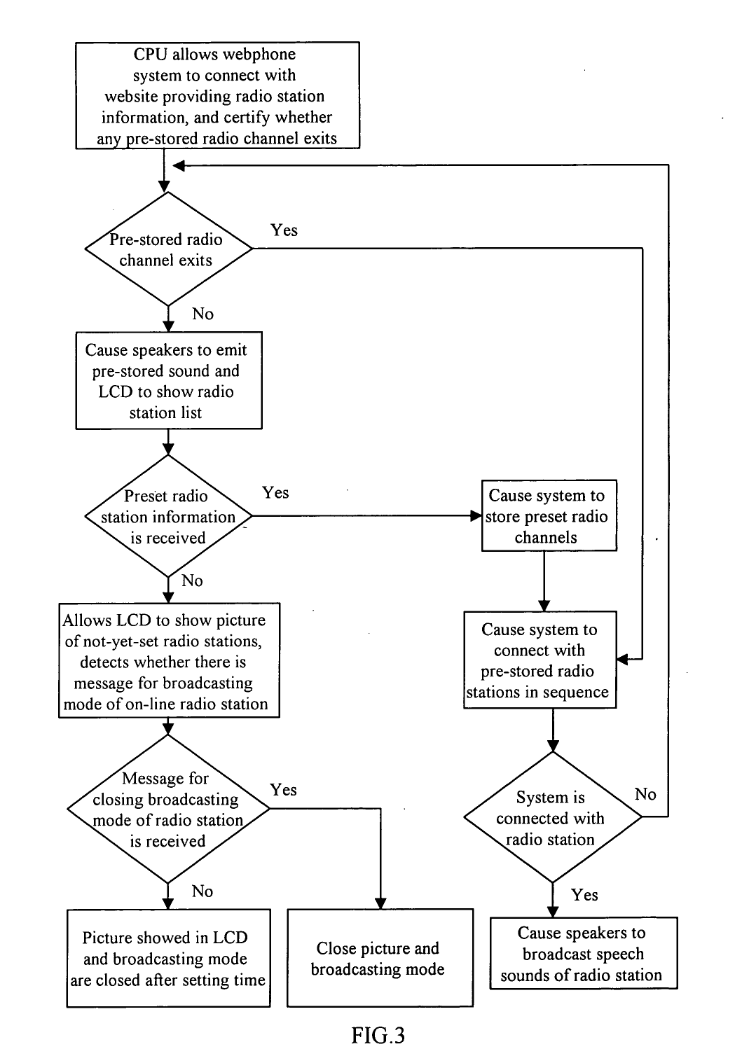

Please refer to FIG. 3. A method for executing a broadcasting mode of an on-line radio station by a webphone system comprises the following steps:
(1) a CPU allows a webphone system to connect a website providing radio station message through Internet, the CPU confirms whether the system stores preset radio channels; if yes, enter Step (5); if no, enter next step;
(2) the CPU causes speakers to emit pre-stored warning speech sounds, and cause a liquid crystal display to display a radio stations list provided by the website;
(3) if the CPU receives message from a preset radio station, it then allows the radio channel to be stored, and enter Step (5); if the CPU does not receive message from a preset radio station, enter next step;
(4) the CPU allows the liquid crystal display to display images of not-yet-set radio stations, and detects whether there is message for closing the broadcasting mode of the on-line radio station; if yes, causes the liquid crystal display to close a picture showing the message for the not-yet-set radio stations, and closes the broadcasting mode of the on-line radio station; if no, causes the liquid crystal display to continue displaying the picture until the end of a preset time, and then closes the picture and causes the system to close the broadcasting mode of the on-line radio station;
(5) the CPU causes the system to connect in sequence with preset radio stations, if the connection is successful, enter next step; if the connection is failed, causes the system to stop the connection, and enter Step (2); and
(6) the CPU caused the speakers to broadcast a real time speech sounds program transmitted form the radio station.

The present invention adds a function for listening to an on-line radio station to a general webphone. Therefore, added value of the webphone is increased, and high use value of a product is oriented. Whereby, a desire to purchase of a consumer is increased.

It is noted that the method for listening to an on-line radio station through a webphone described above is the preferred embodiment of the present invention for the purpose of illustration only, and are not intended as a definition of the limits and scope of the invention disclosed. Any modifications and variations that maybe apparent to a person skilled in the art are intended to be included within the scope of the present invention.

1. A method for listening to an on-line radio station through a webphone, comprising the following steps:
(a) a CPU continuing detecting a webphone system whether there is an incoming phone call or a dialing-out phone call; if yes, allowing said system to close a broadcasting mode of an on-line radio station and to activate a general dialing/receiving mode of a webphone, and entering next step; if no, entering Step (c);
(b) said CPU allowing a line connection to be established among said system and two telephone communication parties; and, detecting whether the line connection between the two parties is terminated; if no, continues detecting; if yes, enter next step;
(c) said CPU allowing said system to activate said broadcasting mode of said on-line radio station;
(d) said CPU allowing said system to execute said broadcasting mode of said on-line radio station; and
(e) said CPU continuing detecting the webphone system whether there is a message for an incoming phone call or a dialing-out telephone.; if yes, causing said system to close said on-line radio station broadcasting mode and to activate said general webphone dialing/receiving mode of said webphone, and then returning to Step (b); if no , returning to Step (d).

2. The method for listening to an on-line radio station through a webphone according to claim 1, wherein a method for executing said broadcasting mode of said on-line radio station comprises the following steps:
(1) said CPU allows said webphone system to connect said website providing radio station message through Internet, said CPU confirms whether said system stores preset radio channels; if yes, enter Step (5); if no, enter next step;
(2) said CPU causes a liquid crystal display to display a radio stations list provided by said website;
(3) if said CPU receives message from a preset radio station, it then allows said radio channel to be stored, and enter Step (5); if said CPU does not receive message from a preset radio station, enter next step;
(4) said CPU allows said liquid crystal display to display images of not-yet-set radio;
(5) said CPU causes said system to connect in sequence with preset radio stations, if said connection is successful, enter next step; if said connection is failed, causes said system to stop said connection, and enter Step (2); and
(6) said CPU caused the speakers to broadcast a real time speech sounds program transmitted form said radio station.

3. The method for listening to an on-line radio station through a webphone according to claim 2, wherein said step (2) further comprises that said CPU causes speakers to emit pre-stored warning speech sounds.

4. The method for listening to an on-line radio station through a webphone according to claim 2, wherein said step (4) further comprises that said CPU detects whether there is message for closing said broadcasting mode of said on-line radio station; if yes, causes said liquid crystal display to close a picture showing the message for said not-yet-set radio stations, and closes said broadcasting mode of said on-line radio station; if no, causes said liquid crystal display to continue displaying said picture until the end of a preset time, and then closes said picture and causes said system to close said broadcasting mode of said on-line radio station
